(19) United States
(12) Patent Application Publication
(10) Pub. No.: US 2010/0145619 A1
(43) Pub. Date: Jun. 10, 2010

(54) COMPUTATION OF ENERGY VALUES FOR ZODIAC DEGREES

(76) Inventor: Earik Beann, Boulder, CO (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/630,424

(22) Filed: Dec. 3, 2009

Related U.S. Application Data
(60) Provisional application No. 61/120,134, filed on Dec. 5, 2008.

(51) Int. Cl. G06F 19/00

(52) U.S. Cl. 702/2

(57) ABSTRACT

A personal computer including a CPU, storage disk, software program and arithmetic logic circuits are used for computing the amount of energy in each degree of the zodiac using the longitudinal positions of various planetary bodies and their angular separations for astrology purposes, cosmology purposes and financial market trading purposes.

### BACKGROUND OF THE INVENTION

1. Field of the Invention

The invention relates to the field of computing the amount of energy for each degree of the zodiac, and specifically to a data processing system for determining the energy values for zodiac degrees which may be used in the fields of astrology, cosmology and to provide financial information that may be useful for market traders.

2. Description of the Prior Art

Astrology has been known for hundreds of years in the use of predicting particular events in different persons lives based on dates and time of birth and geographical locations on the planet earth. Cosmology which is the study of the universe has a usage in computing energy values that relate to the position of the planets in the solar system and the earth's moon that circles the earth for personal event prediction or observations and financial market trends looking for turning points in a market based on the particular alignment of the planets and the moon. It is useful to have a process to compute the power ratings for particular degree values of the zodiac using the blended angular separation values. The present invention provides a data processing method and system for establishing and determining the energy values for the zodiac based on specific time and location on the earth and the relative positions of the planets in the zodiac.

### SUMMARY OF INVENTION

The present invention provides a data processing method and system for providing information flow and data in making all calculations necessary for computing the amount of energy in each degree of the zodiac using the longitudinal positions of various planetary bodies and their angular separations which can be useful in astrology, cosmology and financial market trading applications.

The data processing system determines the planetary positions for the date and time for which the energy is to be computed. The data processing system can then enter the planetary positions in an astrologer's wheel stored in memory which can be displayed as a visual representation of a zodiac. The system will then computes the angular separations between all planets of which there are 44 different combinations. The system also arranges the planets which are ordered by how fast each planet moves in the solar system.

The data processing system qualifies the 44 different aspects of the angular separations of the planets. Once that has been done, the list of 44 aspects is filtered by the data processing system which can also determine whether or not the separation is within a predetermined amount of degrees which can be excluded from the calculations. Finally, the data processing system can generate an array of degree values representing all of the degrees of the zodiac and each degree value having energy counter which is zero initially.

Once the data processing system has computed the zodiac counter values, which is the first part of the process, then the energy values get transferred to a particular geographical location on earth which includes predetermined established points on the earth. The system will generate a graph for visual display that illustrates composition values calculated based on energy values in a representative astrology wheel. Embodiments of the present invention comprises of a personal computer, having a CPU databases and software for computing the amount of energy in each degree of the zodiac using the longitudinal positions of various planetary bodies and their angular separations.

### DESCRIPTION OF THE DRAWINGS

FIG. 1 illustrates an astrologer's wheel.

FIG. 2 illustrates a wheel that correlates energy values to zodiac degrees.

FIG. 3 is a wheel illustrating composition values calculated based on energy values in a wheel.

FIG. 4 is a graph of the values shown in FIG. 3.

FIG. 5 shows a schematic diagram of the data processing systems.

### PREFERRED EMBODIMENT OF THE INVENTION

A personal computer with a CPU, database storage disk, software, and arithmetic logic circuits computes the amount of energy in each degree of the zodiac using the longitudinal positions of various planetary bodies and their angular separations. The procedure is mechanical, and is as follows:

(1) The computer obtains the planetary positions for the date and time for which energy is to be computed. This may be any time in the past or future, but is usually calculated for the current moment. These values may be obtained from many sources, one of which is NASA's Jet Propulsion Laboratory (JPL) Ephemeris data. Typically, geocentric data (from the perspective of the Earth) is used along with the equatorial coordinate system. The planets considered in the calculations are: Moon, Mercury, Venus, Sun, Mars, Jupiter, Saturn, Uranus, Neptune and Pluto. The Moon's Nodes are also used in this calculation as well.

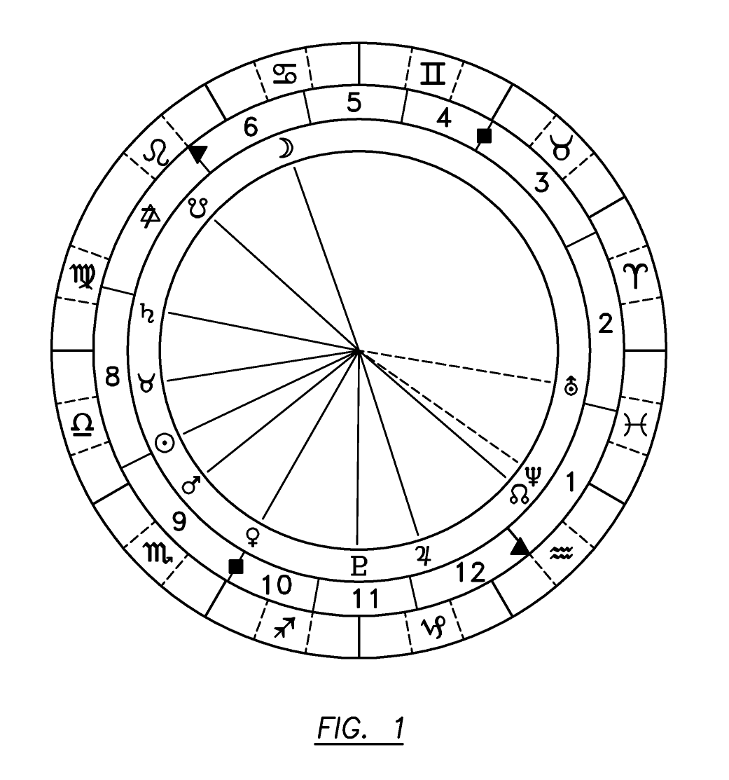

(2) The computer then enters the planetary positions in an astrologer's wheel stored in memory. FIG. 1 illustrates an astrologer's wheel, which is used as a visual representation of the zodiac. Each planetary value will be in the range of 0-359 degrees. This wheel shows various planets as they appear for a particular date, as if looking down on the solar system from the top. The far right is set at 0 degrees (Aries), and the values increase around the wheel in a counter-clockwise direction. For example, the top is set at 90 degrees (Cancer), the left is set at 180 degrees (Libra), and the bottom is set at 270 degrees (Capricorn). This schematic is quite common, but not the only possibility. Each ray from the center represents one planet. For example, at the bottom of the chart there is a symbol that looks like a P, which is Pluto because its value is close to 270 degrees. The computer calculates the positions for a specific time.

(3) In the next step, the computer and CPU compute the angular separations (“aspects”) between all planetary pairs. As 10 planets (Moon, Mercury, Venus, Sun, Mars, Jupiter, Saturn, Uranus, Neptune and Pluto) are considered, there are 44 different combinations. Those planets are ordered by how fast they move in the sky. To obtain an angular separation value, one planet's degree value is subtracted from another, always subtracting the slower planet from the faster one. The values between 0 and 180 degrees are then normalized. If the value is negative, then 360 is added to the value. If the value is greater than 180, then the value is subtracted from 360. For example, if Mercury is at 180 degrees, and Venus is at 45 degrees, then Mercury-Venus aspect would be 135 degrees (180−45). If Mars is at 270 degrees and Jupiter is at 300 degrees, then the Mars-Jupiter aspect would be 330 degrees ((270−300)+360). This is greater than 180, so 360−330=30. All aspect values must fall in the range of 0-180.

(4) The computer must then qualify the aspects. These are 44 different aspects. At this point, the aspects are qualified as follows. If an aspect is qualified, it remains on the list, and if not, it is removed from the list. A qualified aspect is an aspect that is at a specific angular value, plus or minus a fixed error amount (usually 5 degrees). Qualified aspects are based on equal divisions of a circle. A circle has 360 degrees, so qualified values are computed as follows:

360/1=360 (or 0, since 360>180, and 360−360=0)

360/2=180

360/3=120

360/4=90

360/5=72

360/6=60

360/7=51.42

360/8=45

The computer program can continue as necessary the above numerical sequence. A user can set up the desired computer results into order to specify what aspects were considered qualified, but in general 0, 180, 120, 90, and 60 degrees are used. Those are divisions of the circle by 1, 2, 3, 4 and 6.

The CPU provides for filtering of the list of 44 aspects. If the aspects are not within 5 degrees of an ideal value, then they are thrown out. For example, if Mars-Jupiter is 89 degrees, then that is within 1 degree of the ideal 90 degree aspect, so it would remain on the list. If Mars-Saturn is 96 degrees, then it is not within 5 degrees of any of the ideal aspects, so it would get removed from the list. In this way, each of the angular values is checked, and those that are not qualified are removed. For all those values that are qualified, the actual degree value of the aspect is replaced with the ideal one. In the example above, Mars-Jupiter was 89 degrees, so it would be replaced with 90, which is an ideal aspect value. This creates a list of a variable length of all aspects that are qualified.

(5) The computer data processor and software generate an array of degree values from 0-359 representing all degrees of the zodiac. Each degree value has an energy counter, which gets to zero initially. The list of aspects is then traversed by computer calculations, and for each aspect the following occurs:

i. Move to the degree location of the faster planet of the aspect.

ii. Add +1 to the counter at the degree value, and any degree value within our error amount used previously. This means is the error amount is 5 degrees, then 1 is added to each counter value in the zodiac array 5 degrees less than the planet through 5 degrees greater than the planet, remembering that the zodiac is a circle. If the fast planet is situated at 15 degrees, then 1 is added to all degree values from 10-20.

iii. Move forward from the faster planet however many degrees the aspect is. If the fast planet was at 15 degrees, and the degree value was 90, then move to degree 15+90=105.

iv. Repeat the counter increments at this new degree, adding 1 to all degree locations starting 5 degrees back and moving 5 degrees forward from the location. In this example, the location is at 105, so the degree locations degrees 100-110 are incremented.

v. Continue moving forward and incrementing degrees until returning to the initial degree value started on at step i. Note that whole divisions of a circle are used in Step 4 to calculate ideal aspects, so it will return to the starting point. How many different parts of the zodiac counter are incremented depends on what the aspect value is.

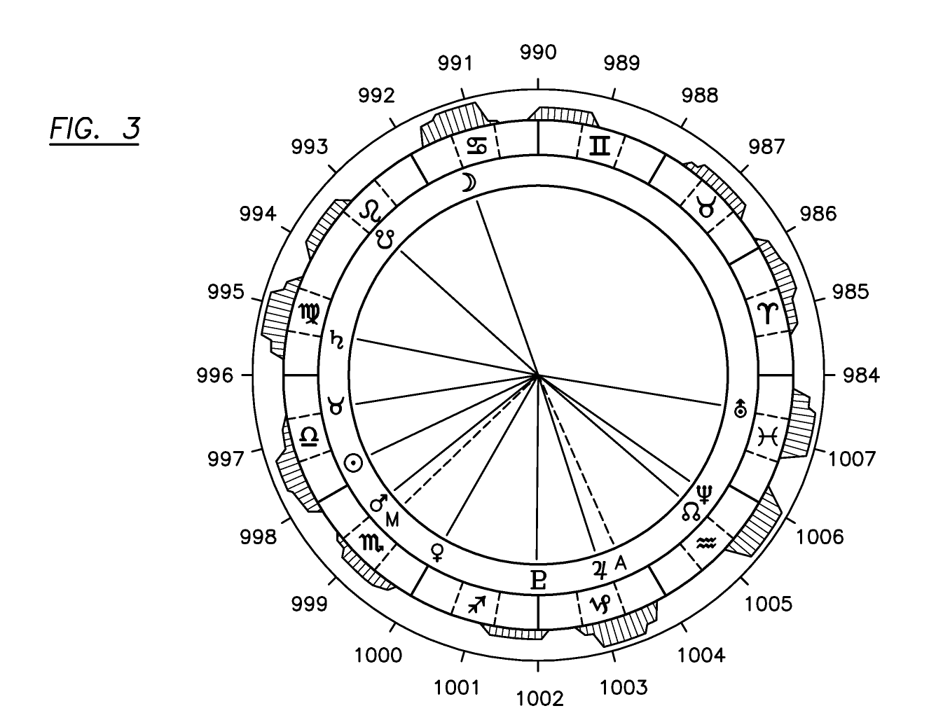

After the data processing is finished with all values in the angular list, an array is generated that represents how much energy each zodiac degree contains at the particular moment. This information is displayed by the computer graphically, using a wheel as shown in FIG. 3.

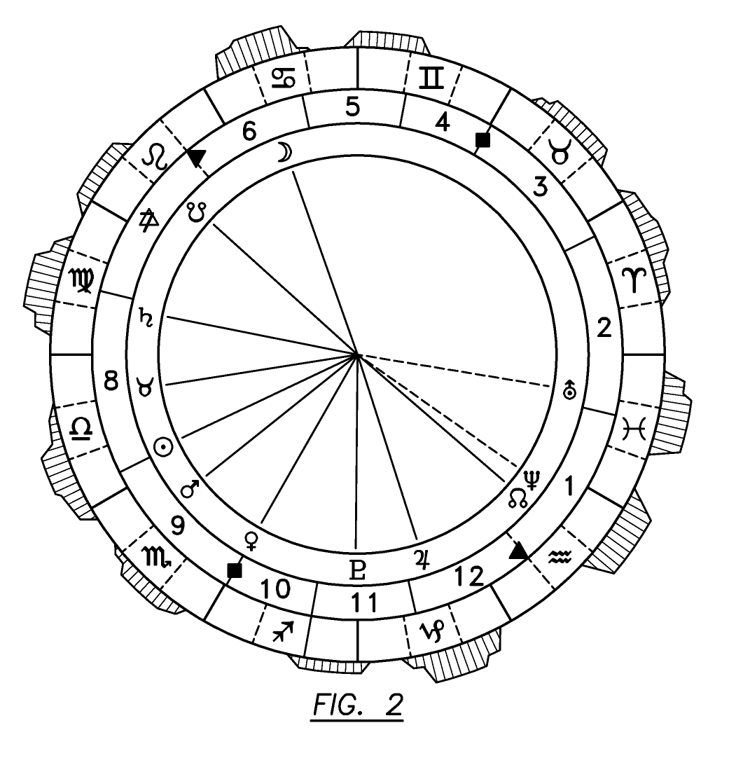

FIG. 3 illustrates a modified astrology wheel that correlates energy to zodiac degrees. In FIG. 2, the bumps around the outside of the wheel are the zodiac counter values drawn by the computer at their appropriate spots. Larger “bumps” represent higher energy areas (larger counter values), and small or flat parts represent low energy areas (low counter values). In FIG. 3, the largest bumps represent the maximum counter values when looking at all degrees from 0-359.

The computer and CPU computing the zodiac counter values was the first part of the process. Next, the user selects and enters into the computer four geographical points are used to measure how this energy gets transferred to a particular geographical location on Earth. The four points are: the Ascendant (degree location of the Eastern horizon), Midheaven (degree location straight up), Descendant (degree location of the Western horizon), and Immum Coeli (degree location directly underneath) for the particular geographical location. These points are common points, and their calculations are in the public domain.

The computer program determines the energy value for a particular time during the day, the degree value of each of these four points are considered to determine what the counter values are for the corresponding degrees. The sum of the four values is used to create a composite value.

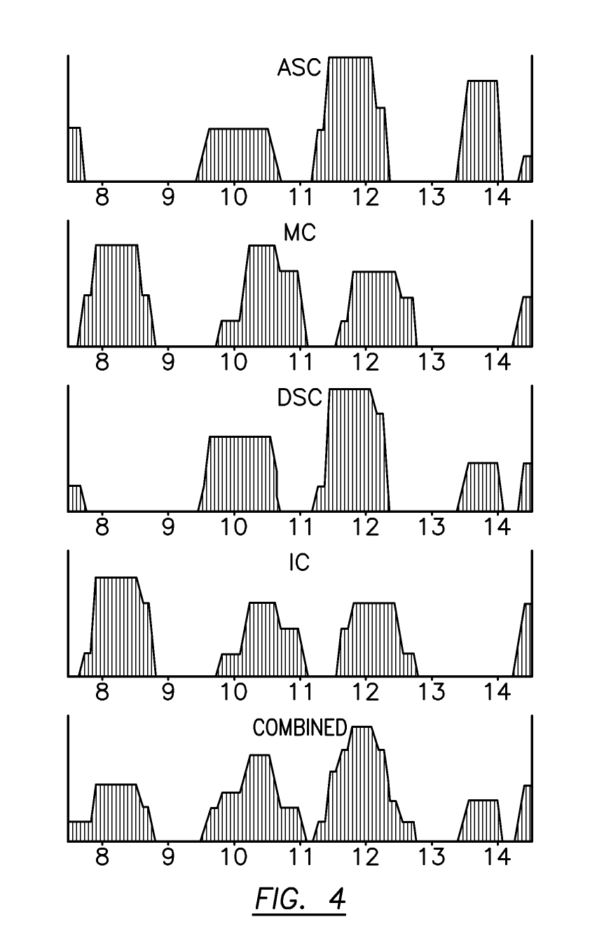

The computer program generates the graph shown in FIG. 4 which is a graph illustrating composition values calculated based on energy values in a wheel. The histograms at the right represent the energy value of the zodiac degree that corresponds with the particular geographical point. This chart was done for New York City on Oct. 20, 2008 at 11:52 Mountain Time. The top histogram is the Ascendant (Eastern point). The plot runs from 7:30 to 14:15 in 5 minute increments. The next graph down is the Midheaven, the third is the Descendant, and the fourth is the IC (underneath point). The bottom histogram is the combination of all four values. The line in the bottom histogram represents a local energy maxima, which is occurring at 11:52 am.

The seven steps outline the data processing system and program software to compute the energy values stored in zodiac degrees, as well as how to use geographical points to determine the to-the-minute energy value. This information may be useful for astrologers, astronomers, and financial market traders. Research suggests that turning points in markets have a statistically higher chance of forming around local maxima and minima in the combined energy plot.

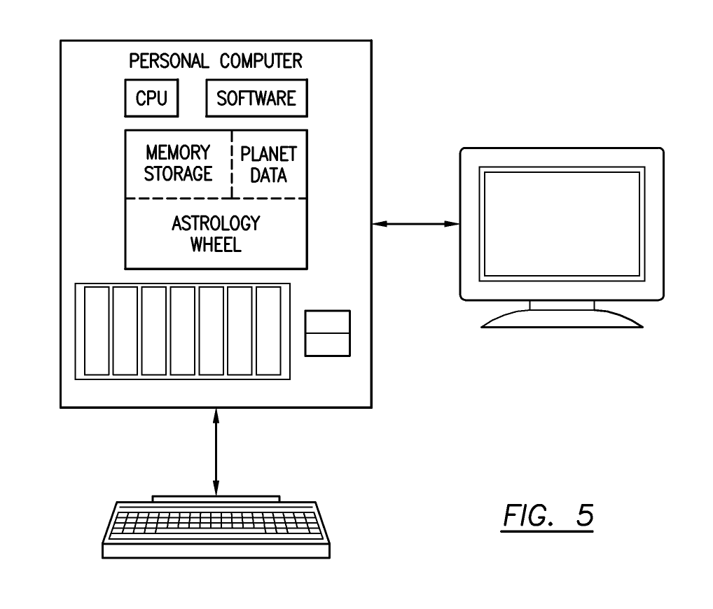

FIG. 5 shows a diagram of the data processing system of the personal computer which includes a CPU, software program video display monitor and key board.

What is claimed is:

1. A data processing system for computing the amount of energy in each degree of the zodiac using the longitudinal positions of various planetary bodies and their angular separations comprising:
(a) a computer processing means for processing data;
(b) storage means for storing data on a storage medium including an astrologers wheel;
(c) first means for obtaining planetary positions for a specific date and time for which energy is to be computed;
(d) second means for entering the planetary positions in an astrologers wheel;
(e) third means for computing angular separation which is the aspects between all planetary pairs including all of the planets in the solar system and the moon that circles the earth based on their positions and establishing different combinations;
(f) fourth means for qualifying the aspects based on a predetermined list;
(g) fifth means for filtering the 44 aspects of the planet locations to provide a list of aspects that are qualifying;
(h) sixth means for generating an array of degree values representing all degrees of the zodiac; and
(i) generating energy in coordination with each degree of the zodiac.

2. A method for computing the amount of energy in each degree of the zodiac using the longitudinal positions of various planetary bodies and their angular separations.
(a) installing a computer processing means for processing data;
(b) providing a storage means for storing data on a storage medium including an astrologers wheel;
(c) obtaining planetary positions for a specific date and time for which energy is to be computed;
(d) entering the planetary positions in an astrologers wheel;
(e) computing angular separation which is the aspects between all planetary pairs including all of the planets in the solar system and the moon that circles the earth based on their positions and establishing different combinations;
(f) qualifying the aspects based on a predetermined list;
(g) filtering the 44 aspects of the planet locations to provide a list of aspects that are qualifying;
(h) generating an array of degree values representing all degrees of the zodiac; and
(i) generating energy in coordination with each degree of the zodiac.
